(19) United States
(12) Patent Application Publication
(10) Pub. No.: US 2021/0042798 A1
(43) Pub. Date: Feb. 11, 2021

(54) CONSUMER-FACILITATED PROPERTY INSPECTION

(71) Applicant: XOME HOLDINGS LLC, Lewisville, TX (US)

(72) Inventor: Mark P. Sennott, Sherborn, MA (US)

(21) Appl. No.: 16/987,871

(22) Filed: Aug. 7, 2020

Related U.S. Application Data
(60) Provisional application No. 62/884,891, filed on Aug. 9, 2019.

(51) Int. Cl. G06Q 30/02; G06Q 50/16; G06Q 40/02

(52) U.S. Cl. CPC G06Q 30/0278; G06Q 40/025; G06Q 50/163

(57) ABSTRACT

Systems and methods for consumer-facilitated inspection of a property. A system comprises a mobile application configured to associate, with inspection imagery captured by the consumer at a property using a mobile device, at least one of a location and time at which the inspection imagery is captured and a server configured to compare at least one of (i) the location associated with the inspection imagery with property location information to verify whether the inspection imagery was captured at the property, and (ii) the time associated with the inspection imagery with a current time to verify whether the inspection imagery reflects a recent condition of the property as defined by a predetermined threshold. The verified inspection imagery provided by the consumer can be used to generate an appraisal or evaluation for use with originating or servicing a loan, assessing property taxes, or evaluating code compliance.

### CROSS-REFERENCE TO RELATED APPLICATION(S)

This application claims the benefit of and priority to U.S. Provisional Application No. 62/884,891, filed Aug. 9, 2019, which is hereby incorporated herein by reference in its entirety for all purposes.

### TECHNICAL FIELD

The present disclosure is directed systems and methods for performing a property inspection and, in particular, engaging a consumer to collect inspection materials for independent and remote evaluation, thereby eliminating the need for an on-site inspection by a licensed professional.

### BACKGROUND

Pressure has been mounting on the appraisal and mortgage lending and servicing industry to continually reduce the time and cost of an appraisal, especially for such things as low risk home equity loans and the ability to quickly determine property values before the property goes into foreclosure. One such example to reduce time is the use of Automated Valuation Models (AVMs). AVMs have gained some acceptance, however the information that AVMs provide is limited, and substantially stems from the use of an algorithm to collect public and other data and make a “guess” at a property's value based on a comparison of similar properties and sales. Often, the information AVMs provide is not verifiable as current and therefore does not satisfy stringent lender documentation requirements, particularly requirements as to the interior and/or exterior condition of the subject property. To insure these stringent requirements are met, lenders and servicers require a large majority of loan applications and servicing procedures to obtain a traditional appraisal to verify the condition of the property. Traditional appraisals often preclude the use of an unlicensed third party to perform the onsite property inspection; this requirement is at least partially due to a concern that information may be manipulated by an interested third party. With an ever-increasing population and corresponding demand for homes as well as the decline in the number of licensed appraisers, the availability of licensed appraisers to travel to each property in a reasonable timeframe is shrinking rapidly. As a result, there are often longer wait times for appraisals, especially during peak housing cycles—in either lending or servicing. The wait times are expected to increase in the future. Therefore, there is a need to increase the efficiency of the appraisal process so that an appraiser can perform more property evaluations in a shorter time, while still avoiding the concern of interested party bias.

### SUMMARY

The present disclosure is directed to a system for consumer-facilitated inspection of a property. The system, in various embodiments, may comprise a mobile application configured to run on a mobile device operated by a consumer and to associate, with inspection imagery captured by the consumer at a property using the mobile device, at least one of a location of the mobile device at the time the inspection imagery is captured and a time at which the inspection imagery is captured; a database containing at least information concerning a location of the property; and a server configured to: receive, from the mobile application, the inspection imagery and associated location and/or time information, receive, from the database, the information concerning the location of the property, and compare at least one of (i) the location associated with the inspection imagery with the property location information received from the database to verify whether the inspection imagery was captured at the property, and (ii) the time associated with the inspection imagery with a current time to verify whether the inspection imagery reflects a recent condition of the property as defined by a predetermined threshold. In various embodiments, the server may include a memory and a processor, the memory containing computer-readable instructions that when executed by the processor cause the server to perform the claimed functions.

The server, in an embodiment, may be further configured to evaluate at least one of the following to determine whether the property is eligible for consumer-facilitated inspection of the property: (i) a complexity of the property, (ii) whether the database contains sufficient information about the property to verify that the inspection imagery was captured at the property, and (iii) whether the consumer has verified, through the mobile application, that the information about the property contained in the database is correct.

The server, in an embodiment, may be further configured to process the inspection imagery provided by the mobile application to identify one or more features of the property present in the inspection imagery from which a condition of the property can be assessed.

The server, in an embodiment, may be further configured to perform at least one of the following functions: (i) provide the verified inspection imagery to a human for performing an appraisal or evaluation, (ii) automatically appraise the value of the property, based at least in part on the verified inspection imagery, using an automated valuation model (AVM), and (iii) use the human-performed appraisal or evaluation and the inspection materials to improve the accuracy of an AVM. The appraisal or evaluation, in various embodiments, may be a loan appraisal or evaluation, or a property tax appraisal or evaluation.

The server, in an embodiment, may be further configured to provide the verified inspection imagery to a property taxing authority as part of a property tax appeals process. In another embodiment, the server may be further configured to provide the verified inspection imagery to a code/permit compliance authority as part of a code/permit compliance process.

The server, in an embodiment, may be further configured to use information about the property obtained from the database to generate and present to the consumer, via the mobile application, instructions and/or requests for collecting the inspection imagery and inspection information.

In another aspect, the present disclosure is directed to a computerized method for consumer-facilitated inspection of a property. The method, in various embodiments, may comprise associating, with inspection imagery captured by a consumer at a property, at least one of a location and a time at which the inspection imagery is captured; receiving information concerning the location of the property; and comparing at least one of (i) the location associated with the inspection imagery with property location information to verify whether the inspection imagery was captured at the property, and (ii) the time associated with the inspection imagery with a current time to verify whether the inspection imagery reflects a recent condition of the property as defined by a predetermined threshold. In various embodiments, the computerized method may be performed by a server including a memory and a processor, the memory containing computer-readable instructions that when executed by the processor cause the server to perform the claimed functions.

The method, in an embodiment, may further include evaluating at least one of the following to determine whether the property is eligible for consumer-facilitated inspection of the property: (i) a complexity of the property, (ii) whether sufficient information about the property is available to verify that the inspection imagery was captured at the property, and (iii) whether the consumer has verified that the available information about the property is correct.

The method, in an embodiment, may further include processing the inspection imagery to identify one or more features of the property present in the inspection imagery from which a condition of the property can be assessed.

The method, in an embodiment, may further include at least one of the following: (i) providing the verified inspection imagery to a human for performing an appraisal or evaluation, (ii) automatically appraising the value of the property, based at least in part on the verified inspection imagery, using an automated valuation model (AVM), and (iii) using the human-performed appraisal or evaluation and the inspection materials to improve the accuracy of an AVM. The appraisal or evaluation, in various embodiments, may be a loan appraisal or evaluation, or a property tax appraisal or evaluation.

The method, in an embodiment, may further include providing the verified inspection imagery to a property taxing authority as part of a property tax appeals process. In another embodiment, the method may further include providing the verified inspection imagery to a code/permit compliance authority as part of a code/permit compliance process.

The method, in an embodiment, may further include using the available information about the property to generate and present, to the consumer, instructions and/or requests for collecting the inspection imagery and inspection information.

In yet another aspect, the present disclosure is directed to another computerized method for generating an appraisal or evaluation of a property. The method, in various embodiments, may include evaluating at least one of the following to determine whether a property is eligible for consumer-facilitated inspection of the property: (i) a complexity of the property, (ii) whether sufficient information about the property is available to verify that the inspection imagery was captured at the property; and (iii) whether the consumer has verified that the available information about the property is correct; if the property is determined eligible, directing a consumer to capture inspection imagery of the property using a mobile device running a mobile application; associating, with the inspection imagery captured by the consumer at the property, a location and a time at which the inspection imagery is captured; verifying, based on the location and time information associated with the inspection imagery, whether the inspection imagery was captured at the property and whether the inspection imagery reflects a recent condition of the property as defined by a predetermined threshold; and if the inspection imagery is verified, performing at least one of the following: (i) providing the verified inspection imagery to a human for performing an appraisal of the property; and (ii) processing the inspection imagery to identify one or more features of the property present in the inspection imagery from which a condition of the property can be assessed, and appraising the value of the property, based at least in part on information about the property condition assessment, using an automated valuation model. In various embodiments, the appraisal or evaluation may be used in connection with originating a loan, servicing a loan, assessing property taxes, or evaluating code compliance.

### BRIEF DESCRIPTION OF THE DRAWINGS

FIG. 1 depicts a schematic view of a system for consumer-facilitated property inspection according to an embodiment of the present disclosure;

FIG. 2 is a flowchart depicting a method for consumer-facilitated property inspection involving according to an embodiment of the present disclosure;

FIG. 3 is a flowchart depicting a method 301 for facilitating consumer collection of property inspection materials using a mobile device and verifying same according to a representative embodiment of the present disclosure;

FIG. 4 is a flowchart depicting another method for consumer-facilitated property inspection involving automated image processing and a human appraiser according to an embodiment of the present disclosure; and

FIG. 5 is a flowchart depicting a method for consumer-facilitated property inspection involving automated image processing and AVM according to an embodiment of the present disclosure.

### DETAILED DESCRIPTION

Embodiments of the present disclosure are directed to systems and methods for consumer-facilitated property inspections, verifying their accuracy, and determining which properties are eligible for the use of the process. More specifically, in various embodiments, the present systems and methods are configured to enable a consumer to collect and transmit imagery and other information about the property using a mobile device for off-site evaluation (e.g., by an inspector, appraiser, or computer algorithm such as an automated valuation model (AVM)). As configured, the present systems and methods may obviate the need for scheduling a traditional on-site property inspection or appraisal by a third party. This, in turn, may improve the consumer and/or lender experience during various commercial transactions (e.g., home equity loans, mortgage loans, and default servicing) by improving convenience, speeding up the inspection and appraisal processes, and reducing cost, amongst other advantages as later described in more detail.

As used herein, the term “consumer” broadly includes any person desiring an inspection of the subject property. Representative consumers include an owner or prospective owner of the subject property, such as a homeowner, borrower, mortgage loan applicant, homebuyer, or authorized designee thereof (e.g., anyone authorized by a lender, taxing authority, or the like to attest to the authenticity of the inspection materials on behalf of the consumer), though one of ordinary skill in the art will recognize other such persons that may be considered consumers within the scope of the present disclosure. The consumer is present at the property and collects imagery and information using a mobile device, as later described in more detail.

As used herein, the term “property” broadly includes any structure(s) and possibly other improvements to real estate, whether residential or commercial in nature. Representative properties include houses, office buildings, retail space, restaurants, and the like. One of ordinary skill in the art will recognize other suitable structures, improvements, and in some cases, the land itself, that may qualify as property within the scope of the present disclosure.

As used herein, the terms “inspection imagery” and “inspection information” broadly include any information about the property that is captured, collected, input, or otherwise provided by the consumer via a mobile device. Representative inspection imagery includes photographs and videos of the property, though any other visual depictions of the property or aspects thereof may be considered inspection imagery. Representative inspection information includes location information, timestamp information, and other information automatically generated by the mobile device as configured in accordance with the present systems and methods. Additionally or alternatively, inspection information may include information manually or otherwise input by the consumer such as indications of what property feature(s) is captured in each inspection image, information concerning possible renovations or additions to the property, tax assessment records, and building permits, amongst other suitable information. In some embodiments, inspection information may be automatically associated with inspection imagery, such as associating location information (e.g., GPS coordinates), timestamps, and feature indications with corresponding images and videos using metadata or any other techniques known in the art. Inspection imagery and inspection information may be collectively referred to herein as “consumer inspection materials.”

As used herein, the term “mobile device” broadly includes any portable electronic device capable of supporting a mobile application and being operated by a consumer collecting inspection materials at the property. Mobile devices, in various embodiments, may include components for capturing images (e.g., a camera or image sensor) and determining a location of the mobile device (e.g., GPS functionality). Representative mobile devices include mobile phones, smart phones, tablets, laptop computers, and the like. In an embodiment, the mobile device may include additional components and/or software features useful for documenting attributes of the property such as the Apple® Measure app or similar functionality configured to be used to measure the size of rooms on the property, for example. The term mobile device may also include more specialized electronic devices, and may encompass consumer or specialized mobile devices as paired with various instruments, sensors, and the like for collecting inspection materials. For example, the term mobile device may envision a smart phone connected to accessories such as an infrared camera (e.g., for detecting plumbing leaks behind walls), a laser measure (e.g., for measuring the size of various rooms on the property), or other tools/instruments/sensors that an appraiser may use or otherwise could be used to collect inspection materials for assessing a condition of the property.

As used herein, the terms “inspector” and “appraiser” refer to persons skilled in property inspections and appraisals, respectively, such as licensed inspectors, licensed real estate agents, and licensed appraisers. One of ordinary skill in the art will understand that the terms inspector and appraiser, as used herein, may refer for example to such persons engaged by typical lenders and servicers such as financial institutions, mortgage lenders, mortgage loan servicers, underwriters, and the like, but may in some embodiments refer to such persons engaged by governmental taxing authorities, code compliance authorities, and any other persons or entities seeking property inspection and/or valuation information, as later described in more detail.

As used herein, the term “lender” broadly includes any person, entity, or designee thereof that may request or otherwise seek or use information generated by the present systems and methods (including that generated by inspectors and/or appraisers) for any suitable commercial purpose such as, without limitation, generating or otherwise evaluating a property valuation, evaluating a loan application, and servicing loans (e.g., as part of the foreclosure, short sale, loan modification, private mortgage insurance removal, etc.) associated therewith as later described in more detail. For clarity, the term “lender” is merely used for simplicity; the term includes not just lenders, but also servicers and others fitting the preceding definition. Further, while the present systems and methods are often described herein in the context of loan origination examples, it should be recognized that such examples are not intended to be limiting and that one of ordinary skill in the art will recognize, with the benefit of the present disclosure, how to adapt such examples to other use cases, such as loan servicing. One of ordinary skill in the art will also understand that the term lender, as used herein, may refer for example to typical lenders and servicers such as financial institutions, mortgage lenders, mortgage loan servicers, underwriters, and the like, but may in some embodiments refer to governmental taxing authorities, code compliance authorities, and any other persons or entities seeking property inspection and/or valuation information, as later described in more detail.

The terms “inspection”, “evaluation”, and “appraisal” (and derivatives thereof such as use in verb form) are often used herein when referring to assessing a condition and/or valuation of a property. Generally speaking, the term “inspection” refers to assessing a condition of the property and may be performed by a licensed inspector, a person not necessarily licensed as an inspector, or through image processing/artificial intelligence; the term “evaluation” refers to assessing a condition and/or value of a property and may be performed by a person not necessarily licensed as an inspector or appraiser or through image processing/artificial intelligence; the term “appraisal” refers to assessing a value of a property by a licensed appraiser It should be recognized that the present disclosure is not intended to be limited to any one particular use (i.e., inspection, evaluation, or appraisal) and thus terms may be substituted for one another throughout the present disclosure as consistent with the surrounding context. Further, the terms “evaluation” and “appraisal” are intended to be used in accordance with the above definitions and are not necessarily limited by the specific definitions set forth under the Uniform Standards of Professional Appraisal Practice (USPAP) and the Office of the Comptroller of the Currency (OCC) regulations.

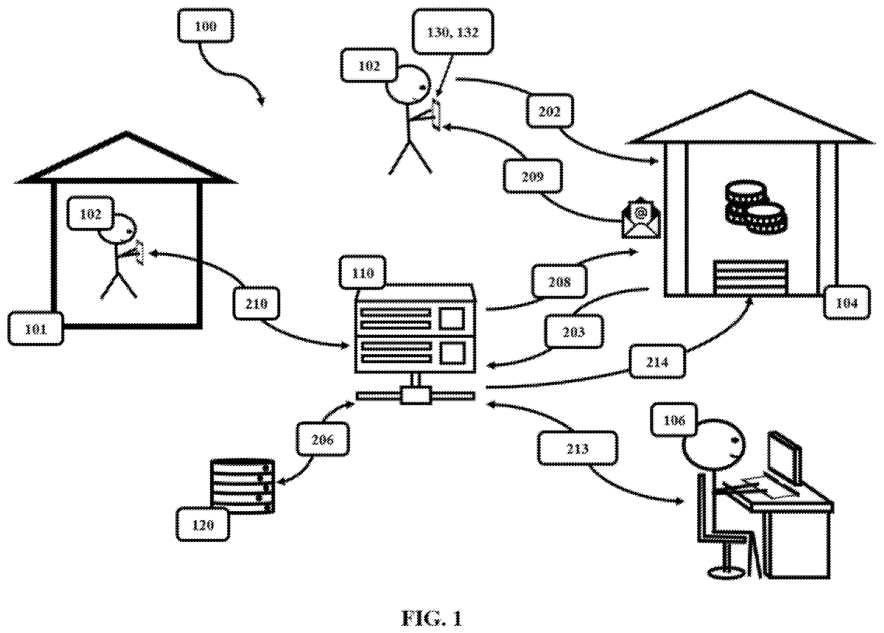

FIG. 1 depicts a schematic view of a system 100 for consumer-facilitated property inspection according to an embodiment of the present disclosure. In particular, system 100 may be configured to automatically assess the eligibility of a particular property for consumer-facilitated inspection, automatically direct the consumer in collecting consumer inspection materials about the property, and automatically verify the authenticity of the inspection materials and/or suitability of the property for evaluation by at least one of an inspector, appraiser, AVM, or other suitable person, entity, or technology, as further described in more detail in the present disclosure.

As shown FIG. 1, system 100, in various embodiments, may generally comprise a server 110, one or more databases 120, and a mobile application 132 configured to run on a mobile device 130.

Server 110 may include a memory 112 (not shown) containing computer-readable instructions for performing methods of the present disclosure and a processor 114 (not shown) configured to read and execute the computer-readable instructions stored on memory 112. In various embodiments, server 110 may be a cloud server or other remotely-located server configured to send and receive information, requests, and instructions to and from database(s) 120 and mobile application 130 via one or more wired or wireless communications links. While the present disclosure refers to component 110 as a server, it should be recognized that component 110 may include any suitable computer hardware for storing and executing computer-readable instructions for performing various methods described herein and thus the present disclosure should not be limited to any one particular hardware embodiment of server 110.

Database(s) 120, in various embodiments, may store various types of information and analytics technologies used in connection with performing the methods of the present disclosure. For example, database(s) 120, in an embodiment, may include one or more databases containing public or other information about the property, such as Multiple Listing Service (MLS) data, building permit data, local or state tax assessment data, and previous inspection services or appraisal services data. Additionally or alternatively, in an embodiment, database(s) 120 may include one or more databases containing proprietary information about the property, as well as proprietary or paid for analytics technology such as AVMs, or other data analytics. For ease of description, database(s) 120 may be referred to going forward as a singular database, though it should be recognized that database 120 may include any number of databases suitable for providing information as described in the present disclosure. In operation, sever 110 may be configured to access information and analytics technologies on database 120 via a communications link(s) therebetween to assist with performing methods of the present disclosure, such as when assessing the eligibility of the property for consumer-facilitated inspection, directing the consumer in collecting consumer inspection materials about the property, verifying the authenticity of the inspection materials and/or suitability of the property for evaluation.

Mobile application 132, in various embodiments, may be configured to facilitate and direct the consumer in using mobile device 130 to collect consumer inspection materials about the property. For example, mobile application 132 may provide instructions to direct the consumer in capturing inspection imagery, as well as automatically capture inspection information such as information concerning a location of the mobile device and a time at which inspection imagery is captured. As used herein, the terms “time” and “timestamp” and derivatives thereof, when used in the context of identifying when inspection imagery and/or inspection information is captured, may refer to any one or combination of the date of capture (e.g., “2019” or “January 2019” or “May 15, 2019”) and the time of capture (e.g., 3:15 pm). Mobile application 132, in various embodiments, may transmit inspection imagery and/or inspection information to server 110 for verification of its authenticity and/or suitability for evaluation, as later described in more detail. Of course, in an embodiment, these functions could instead be performed by mobile application 132 locally on mobile device 130.

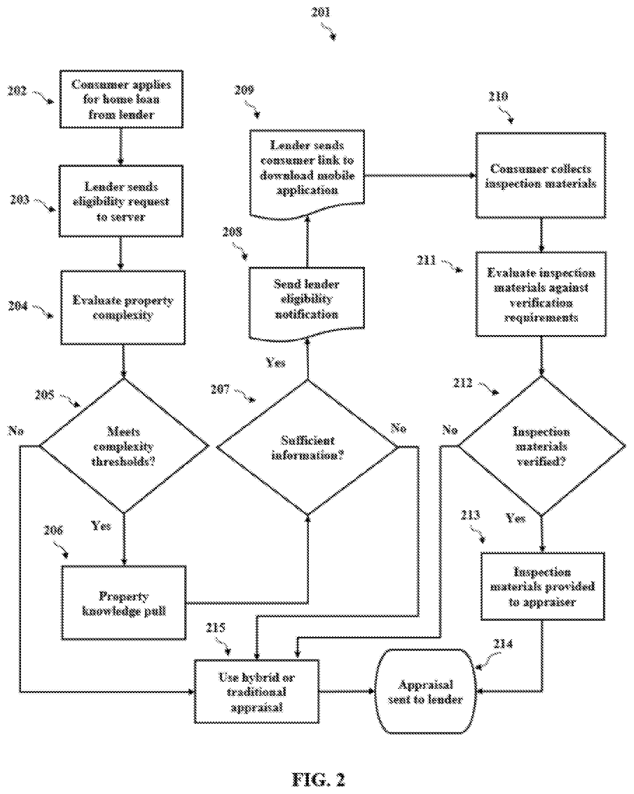

FIG. 2 is a flowchart depicting a method for consumer-facilitated property inspection according to an embodiment of the present disclosure. Viewed in combination, FIG. 1 and FIG. 2 illustrate system 100 as used in an exemplary loan origination appraisal process 201. As shown, system 100 may be configured to evaluate information provided by a lender 104 to assess the eligibility of property 101 for consumer-facilitated inspection and ultimately provide an appraiser 106 with sufficient imagery and information about property 101 to generate an appraisal for use by lender 104. It should be recognized that the exemplary loan appraisal process 201 is merely illustrative of just one potential commercial application of system 100 and that loan appraisal process 201 could be adapted to other applications such as loan servicing, property tax appraisals/protests, and the like without departing from the scope of the present disclosure.

More specifically, the exemplary loan appraisal process 201 may begin with consumer 102 applying for a loan (e.g., home equity loan for property 101) from lender 104 at step 202. Upon receiving consumer's 102 home loan application, lender 104 may send a request to server 110 to assess whether property 101 is eligible for use with system 100 at step 203. Server 110 may process lender's 104 request and assess, in accordance with steps 204-207, whether property 101 is eligible for consumer-facilitated inspection using system 100.

One of ordinary skill in the art will recognize that the exemplary loan origination appraisal process 201 could be adapted to reflect an exemplary loan servicing appraisal process. In a loan servicing scenario, lender 104 may seek an appraisal while servicing an existing loan because, for example, the borrower intends to refinance the loan, lender 104 or the borrower need to modify the loan terms, or lender 104 needs to help borrowers remove required private mortgage insurance or, if the loan is delinquent, to help the borrower to avoid foreclosure via a short sale or other disposition method known in servicing. Accordingly, to adapt process 201 to an exemplary loan servicing appraisal process, step 202 could be modified such that the process 201 begins with a borrower requesting from lender 104 to refinance or modify the current loan terms and condition s and/or lender 104 reaching out to a borrower to modify the terms and conditions of the loan. In the context of an exemplary loan servicing example, lender 104 would refer to a loan servicer.

One of ordinary skill in the art will recognize that steps 402 and 502 of processes 401 and 501 (later described), respectively, could be modified in like manner to adapt those exemplary loan origination processes to exemplary loan servicing processes (with lender 104 referring to the loan servicer). Likewise, loan origination processes 202, 402, and 502 could be adapted to an exemplary property tax appraisal process by modifying steps 201, 401, 501 such that these processes begin with, for example, a consumer 102 (e.g., a homeowner or businessowner) protesting a taxing authority's appraisal of his property 101. Lender 104 (i.e., the taxing authority) and consumer 102 would then follow these processes to provide lender 104 with verified inspection imagery as evidence of the condition of property 101 for consideration in determining appropriate adjustments to the taxing authority's initial appraisal of the property. Similarly, loan origination processes 202, 402, and 502 could be adapted to an exemplary code compliance evaluation process by modifying steps 201, 401, 501 such that these processes begin with, for example, a consumer 102 (e.g., a homeowner, businessowner, construction contractor) requesting a code compliance authority's approval that renovations or additions to the property 101 meet property code requirements. Lender 104 (i.e., the code compliance authority) and consumer 102 would then follow these processes to provide lender 104 with verified inspection imagery as evidence for consideration in determining whether the renovations or additions meet applicable property code requirements. In light of these examples and teachings of the present disclosure, one of ordinary skill in the art will recognize how to adapt the systems and methods described herein to other use cases.

### Assessing Eligibility Based on Property Complexity

In particular, at steps 204-205, server 101 may first pre-screen eligibility of property 101 for consumer-facilitated inspection by evaluating the complexity of property 101 based on information provided by lender 104. This complexity evaluation, in turn, may be used to assess whether property 101 meets certain threshold criteria required for performing consumer-facilitated inspection using system 100.

Server 100, in various embodiments, may evaluate the complexity based at least in part on physical characteristics of property 101, such as whether the structure is one-story vs. multi-story, single-family/detached vs. multi-family/attached, new vs. old, original vs. renovated, etc. For example, property 101 may be considered less complex if it is a relatively new, one-story, single-family/detached structure, as such a structure may not require as much information to appraise compared to an older, multi-story, multi-family attached structure. Complexity, in an embodiment, may also be assessed based on the location of property 101, and more specifically, deemed more complex (or otherwise not eligible for use with system 100) if property 101 is located in an area for which property data is limited, such as in some rural or undeveloped areas.

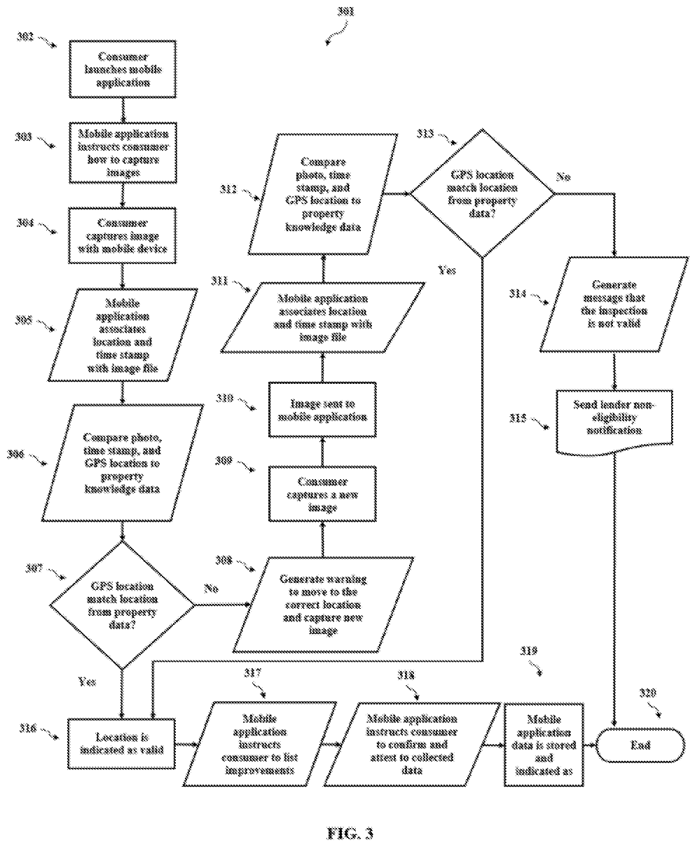

Additionally or alternatively, complexity may be assessed from the perspective of whether inspection information collected by mobile device 130 can be verified within acceptable tolerances. For example, as later described in more detail with respect to FIG. 3, system 100 may be configured to use GPS coordinates provided by consumer's mobile device 130 to verify that consumer inspection materials were indeed collected by mobile application 132 at property 101. Depending on technological and infrastructure limitations, GPS coordinates generated by consumer mobile phones are typically accurate enough to verify whether consumer inspection materials were collected at a particular single-family/detached home since nearby structures are typically far enough away to be beyond any error range associated with GPS accuracy. Conversely, it may be more difficult to verify that consumer inspection materials were in fact collected within a particular unit of a multi-family/attached structure given the close proximity of adjoining units. Likewise, it may be more difficult for system 100 to verify that consumer inspection materials were in fact collected within a particular unit of a multi-story, multi-family/attached structure, as GPS coordinates may not provide a reliable indication of altitude—i.e., on which floor the inspection information and inspection imagery were collected. Accordingly, such structures may be evaluated as more complex given potential difficulties in verifying consumer inspection materials with an acceptable level of confidence. It should be recognized that GPS is merely being used as an illustrative example to help describe possible technological limitations posed by a particular class of mobile devices 130, and that the present disclosure is not intended to be limited to verifying only location, let alone GPS-based location verification or any particular technology that can be used to determine or otherwise estimate a location of mobile device 130.

Additionally or alternatively, server 100 may be configured to evaluate complexity based at least in part on the level of risk associated with the type of loan being applied for or being serviced. For example, home equity loans are typically considered lower-risk transactions and thus system 100, in an embodiment, may consider property 110 as being less complex than a similar property for which consumer 102 is seeking a higher risk loan, such as a new mortgage. Properties that have barns or outbuildings, properties with views of water or properties that are atypical to the neighborhood (a dome house) are examples. In various embodiments, system 100 may be configured such that lender 104 may determine which criteria to consider in evaluating complexity, as well as relative weightings for each and associated thresholds for determining whether property 101 is too complex for consumer-facilitated inspection using system 100. If at step 206 property 101 is assessed as being too complex for consumer-facilitated inspection, server 110 may notify lender 104 so that lender 104 may direct consumer 102 to either schedule a traditional on-site inspection or use a hybrid approach (later described).

### Assessing Eligibility Based on Available Property Information

Additionally or alternatively, server 110 may assess the eligibility of property 101 for consumer-facilitated property inspection based on the availability of additional information regarding property 101 in database 120.

In particular, with reference to steps 206 and 207, if property 101 is assessed as compatible with (i.e., not too complex for) consumer-facilitated inspection, server 110 may access database 120 to assess how much and what kinds of additional information may be available regarding property 101. In particular, in an embodiment server 110 may assess whether database 120 contains any additional information necessary (beyond that provided by lender 104 and consumer 102 via mobile application 132) for appraiser 106 to be able to generate a satisfactory appraisal and/or evaluation. Additionally or alternatively, in another embodiment server 110 may assess whether database 120 contains sufficient information to verify inspection imagery and/or inspection information collected by mobile application 132. For example, in some embodiments, server 110 may be configured instruct mobile application 132 to provide warnings to consumer 102 if photos and/or videos are not taken of every known room in the house or the consumer forgot to take a photo of the exterior of property 101. Accordingly, in such embodiments, server 110 may be configured to assess whether database 120 includes information about the number and types of rooms in the house (e.g., 3 beds, 2 baths, 1 dining room, 1 kitchen). Mobile application 132, in some embodiments, server 110 may be configured to provide information retrieved from database 120 for display on mobile application 132 so that consumer 102 can verify (e.g., tapping “correct”) or correct (e.g., input the correct information) the information via mobile application 132. Additionally or alternatively, in yet another embodiment server 110 may assess whether database 120 contains sufficient information to generate guidance specifically tailored to property 101 for presentation to consumer 102 via mobile application 132 while consumer 102 collects inspection imagery and inspection information. For example, if the property knowledge pull indicated that there have been recent renovations to the property and/or the consumer answered questions about recent renovations or improvements to property 101, system 100 may be configured to request certain types of photos of the renovations or improvements to confirm the information. In addition, if the consumer fails to take photos of all the known rooms of the property, mobile application 132 may guide the consumer to correct the mistake before the inspection is completed. Server 110 may retrieve relevant information from database 120 either as part of assessing whether database 120 contains sufficient information to proceed or after having made such an assessment based on reviewing an index or other indication of what is contained in database 120.

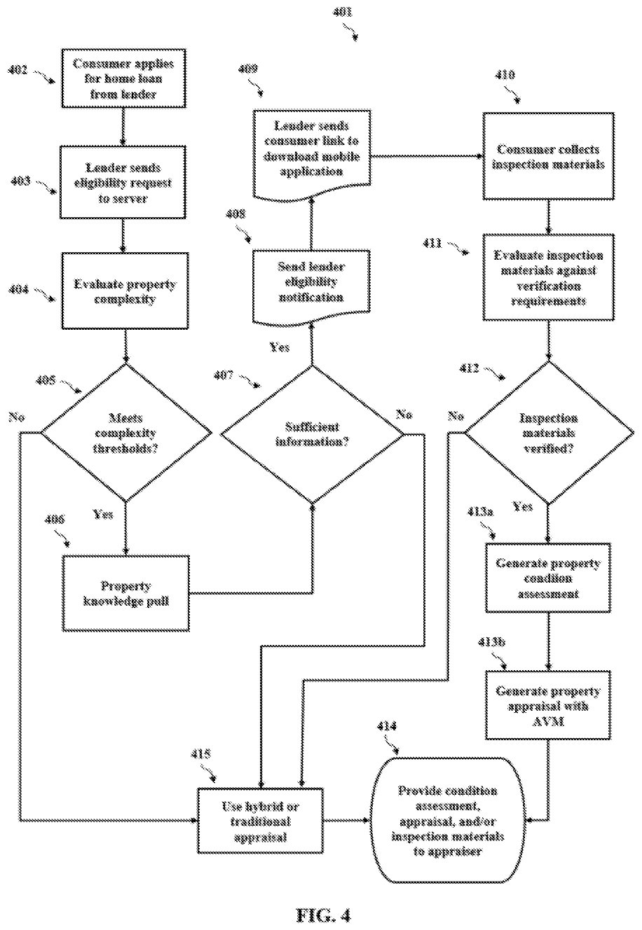

If at step 207 the server 110 determines that database 120 contains sufficient information to proceed, at step 208 server 110 may notify lender 104 that pre-screening steps 204-207 indicate that property 101 is an acceptable candidate for consumer-facilitated inspection. Lender 104 can then direct consumer 102 to download mobile application 132 at step 209 and begin the consumer-facilitated inspection and verification processes set forth in steps 210-212, as later described in more detail with respect to FIG. 4. Assuming consumer 102 successfully performs step 210, and server 110 (and/or, in an embodiment, mobile application 132 locally) verifies the authenticity and/or sufficiency of the consumer inspection materials collected, then at step 213 system 100 may provide the inspection imagery, inspection information, and other relevant information (e.g., information from the loan application and/or the property knowledge pull from database 120) to appraiser 106 so that appraiser 106 may perform an appraisal of property 101. Upon completing the appraisal, appraiser 106 may provide the appraisal to lender 104 for evaluation in the context of the transaction at step 214.

Alternatively, if at step 207 the server 110 determines that database 120 does not contain sufficient information to proceed, server 110 may notify lender 104 so that lender 104 may instead direct consumer 102 to either schedule a traditional on-site inspection or use a hybrid approach (later described).

### Collecting and Verifying Consumer Inspection Materials

FIG. 3 is a flowchart depicting a method 301 for facilitating consumer collection of property inspection materials using a mobile device and verifying same according to a representative embodiment of the present disclosure. Method 301, in an embodiment, may describe in more detail steps 210-212 of method 201 of FIG. 2.

Referring first to step 302, consumer 102 is present a property 101 and opens mobile application 132 on mobile device 130. Mobile application 132, in various embodiment, may configured mobile device 130 for collecting inspection imagery and inspection information. For example, in an embodiment, mobile application 132 may initialize a camera of mobile device 130 in preparation or capturing inspection information, such as photographs and videos, of property 101. Additionally or alternatively, mobile application 132 may initialize features of mobile device 132 for determining a location of mobile device 132, such as associated hardware and software for determining GPS coordinates of mobile device 130. One of ordinary skill in the art will recognize additional features of mobile device 130 to be configured by mobile application 132 in preparation for collecting inspection materials in accordance with the present disclosure.

At step 303, mobile application 132 may display on mobile device 130 instructions for guiding consumer 102 in collecting inspection materials for property 101.

In some embodiments, the instructions may be standard instructions presented of all users of mobile application 132, while in other embodiments the instructions may be tailored at least in part to the subject property 101 and/or consumer 102. In particular, in one such embodiment, mobile application 132 may present one or more inquiries to consumer 102 and tailor its instructions based on the responses provided by consumer 102. For example, mobile application may present inquiries about property 101 layout of the property (e.g., square footage, number of stories, number of rooms, types of rooms, whether any additions or significant improvements have been made, and the like) such that mobile application may determine things like how many photographs and videos to instruct the consumer to take, what kinds of location verification technologies may be available at property 101 (e.g., GPS, internet protocol address, etc.), and other criteria for facilitating consumer 102 in collecting suitable inspection materials. In another embodiment, mobile application 132 (or server 110, remotely) may be configured to use information retrieved from database 120 to automatically tailor such instructions in like manner for presentation to consumer 102 on mobile device 130.

In a representative embodiment, mobile application 132 may direct consumer 102 to capture one or more photographs, videos, or other forms of inspection imagery using mobile device 132. For example, in an embodiment, consumer 102 may be directed to take two photographs of each room, as well as 360 degree videos of high-value rooms such as kitchens, master bathrooms, and the master bedroom. As inspection imagery is captured, mobile device 132 may associate inspection information such as location and timestamp information obtained from mobile device 130 with each such photograph and video at step 305 for subsequent verification.

Mobile application 132, in some embodiments, may provide feedback and further guidance to consumer 102 while collecting inspection materials. For example, in an embodiment, mobile application 132 may instruct consumer 102 to move to a central area of property 101 in preparation for verifying a location of mobile device 130. Doing so may help mobile device 132 (or server 110, remotely) in verifying location information as later described, without having to account for whether or not the location information may have been provided, for example, at a periphery of property 101 which may unnecessarily result in a failed location verification if error tolerances in the location technology show that mobile device is instead (or otherwise may be) located on another property, such as an adjoining property. As another example, mobile application 132 additionally or alternatively may be configured to monitor signal strength of mobile device 130 before a given photo or video is captured to confirm that the signal is strong enough to be able to obtain location information. Additionally or alternatively, mobile application 132 may simply check that location information of suitable fidelity was available and obtained when each photo or video was captured. As configured, mobile application 132 may help avoid a situation where consumer 102 has to repeat the process later because information required for verification purposes was unavailable or insufficient the first time. Additionally or alternatively, mobile application 132 may be configured to evaluate properties of the inspection imagery to confirm that inspection imagery is of sufficient quality for use by appraiser 106 or automated inspection assessments performed by server 110. For example, mobile application may use techniques known in the art to evaluate the lighting, clarity, and focus of inspection imagery, as well as evaluate measurement provided by various inertial sensors of mobile device 132 to confirm whether the inspection imagery was captured from angles and positions providing sufficient field of view of each room in property 101 (e.g., determine that two photos were taken with mobile device 130 oriented in opposing directions to ensure a combined wide field of view of a given room). Mobile application 132, in an embodiment, may additionally or alternatively direct consumer 102 to capture 360-degree videos and/or panoramic images of one or more rooms or areas of property 101 when it is desired to capture inspection imagery of the entirety of such rooms/areas. Likewise, mobile application 132 may be configured to evaluate measurement provided by various inertial sensors of mobile device 132 to confirm whether the inspection imagery depicts the entire room/area. Additionally or alternatively, in an embodiment, mobile application 132 may be configured to transmit inspection imagery for remote display to a person, such as an inspector or appraiser or third party, for immediate or otherwise fast review and approval, either before capturing additional imagery or before submitting all captured imagery to server 110 for evaluation in accordance with the methods described herein.

Continuing to steps 306 and 307, mobile application 132 (or server 110, remotely) may compare location information associated with the inspection imagery with location information for property 101 retrieved from database 120. If the location information from mobile device 130 matches (or is otherwise within acceptable tolerances) of the location of property 101 as retrieved from device 130, then mobile application 132 may display a confirmation and the method may continue to step 317. If instead the location information does not match or is otherwise unsuitable for being verified, mobile application 132 may notify consumer 102 and repeat the process, as shown in steps 308-313. If proper verification is subsequently achieved, then the process may continue to step 317; however, if proper verification is not subsequently achieved, mobile application 132 may notify consumer 102 that the inspection materials cannot be verified and ultimately may notify lender 104 to pursue a traditional or hybrid appraisal (later described). Similarly, at step 307, mobile application 132 (or server 110, remotely) may verify whether enough inspection imagery was captured and is of sufficient quality in order to proceed to step 317. Likewise, at step 307, mobile application 132 (or server 110, remotely) may verify that the timestamps associated with inspection information are recent enough to fall within parameters set by lender 104. For example, lender 104 may require that inspection materials were collected within a predetermined threshold of time, such as within the past 30 days, and thereby reflect the current state of property 101 in order to close the loan.

Continuing to step 317, if the inspection materials are successfully verified, mobile application may optionally present consumer 102 with an interface for entering additional information about property 102 for consideration by appraiser 106 and/or server 110 while performing the appraisal.

At step 318, mobile application 132 may optionally require consumer 102 to attest that the inspection materials collected and provided by consumer 102 were collected at property 101 and are true and accurate. This additional layer of verification may be desirable to lender 106 since the inspection materials are being provided by consumer 102 (an interested party to the transaction) rather than by a licensed inspector/appraiser (a disinterested party in the transaction).

### Property Inspection and Appraisal

Referring back to FIG. 2, in an embodiment server 110 may provide the appraisal materials to appraiser 106 for use in performing an appraisal of property 101. Appraiser 106, in various embodiments, may perform the appraisal according to techniques known in the art. For example, in an embodiment appraiser 106 may view the inspection imagery to assess the condition of property 101 (e.g., identify style, quality of fixtures and improvements, required repairs, and the like) and determine an associated value based on the assessed condition, inspection information provided by consumer 102 (e.g., notes input into mobile application 132), and information about property 101 retrieved by server 110 from database 120, along with other factors typically considered by appraisers such as recent sales of comparable properties in the area and the like.

FIG. 4 is a flowchart depicting another method 401 for consumer-facilitated property inspection involving automated image processing and a human appraiser according to an embodiment of the present disclosure. The method of FIG. 4, in various embodiments, may be substantially similar to that of FIG. 2, except that server 110 may perform additional tasks that may otherwise be performed by appraiser 106 in the method of FIG. 2.

With reference to step 413a, in one such embodiment server 110 may be configured to automatically assess the condition of property 101 based on the inspection imagery using image processing techniques known in the art. In particular, server 110 may process the inspection imagery provided by mobile application 132 to identify one or more features of property 101 present in the imagery from which condition may be assessed. Server 110, in an embodiment, may generate a listing of these features to facilitate appraiser 106 in performing the appraisal. Additionally or alternatively, in an embodiment server 110 may be further configured to generate an assessment of the condition of property 101 based on the features identified in the inspection imagery. For example, server 110 may reference the identified features against a relational table that associates each identified feature with a condition indicator (e.g., undamaged granite countertops=excellent; damaged windows=poor) and relative weighting factor for assessing the overall condition of property 101. Server 110, in an embodiment, may provide the property condition assessment (or assessment of individual features) to appraiser 106 to facilitate appraiser 106 in performing the appraisal. Alternatively, system 100 could automate the entire inspection process, thereby obviating the need for a licensed inspector (or the need for appraiser 106 to have inspection skills) (not shown).

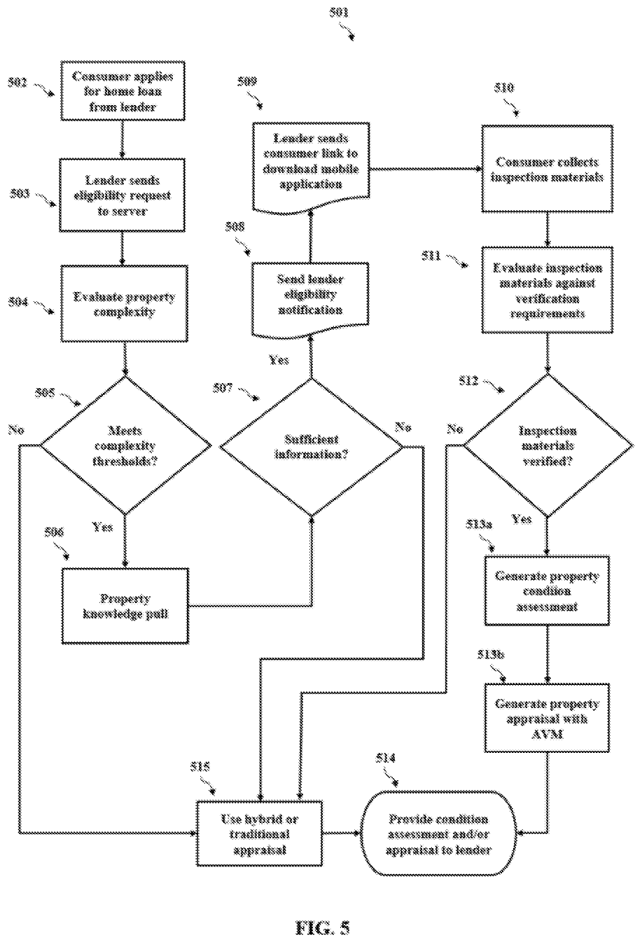

With reference now to step 413b, server 110, in various embodiments, may be further configured to automatically estimate the value of property 101 using an AVM. In one such embodiment, server 110 may utilize, as inputs to the AVM, the property condition assessment generated at step 413a and property information retrieved from database 120. As configured, system 100 could automate the entire evaluation or appraisal process, thereby obviating the need for a licensed appraiser 106 and step 414. Such an embodiment is depicted in method 501 of FIG. 5, whose steps are substantially similar to those of method 401 of FIG. 4 except that server 110 may provide the condition assessment generated in step 513a and/or the appraisal generated in step 513b directly to lender 104 rather than to an appraiser 106. Alternatively, server 110 may provide the automatically-generated appraisal to appraiser 106 to facilitate appraiser in performing his/her appraisal as shown in step 414.

System 100, in yet another embodiment, may be configured to improve automated techniques for assessing property condition and/or property valuation. In particular, in embodiments of system 100 involving a human appraiser 106, system 100 may be further configured to compare the appraiser's appraisal to such automatically-generated assessments of condition and/or value to evaluate how closely the automated assessments of condition and/or value match the human-generated appraisal. To the extent the automated assessment of condition and/or value diverge from corresponding aspects of the human-generated appraisal, server 110 may facilitate improvement of the underlying algorithms by: (i) identifying the divergences to human programmers for consideration of how the automated assessments may be improved, (ii) applying artificial intelligence or other algorithms to identify and test modifications to the automated assessments and thereby automatically improve the automated assessments, or (iii) performing a combination of (i) and (ii).

### Additional Applications

System 100, in various embodiments, may be used in any number of additional applications beyond property-related financing.

For example, as previously noted, in various embodiments system 100 may be utilized by governmental entities for property tax purposes. More specifically, in an embodiment, system 100 may be adapted to provide verified inspection materials and/or any automated condition or valuation assessments to property tax appraisers to facilitate the generation of a tax appraisal for property 101. As configured, system 100 could reduce cost and manpower required for taxing authorities to generate property tax appraisals and may provide for more consistent and fair results.

Similarly, system 100 as adapted could be used by consumer 101 to facilitate efforts to protest a local taxing authority's appraisal of property 101. In one such embodiment, system 100 may allow consumer 102 to provide the taxing authority with verified inspection materials for consideration by the tax appraisers in connection with the consumer's protest. For example, consumer 102 may believe that the property tax appraisal is not accurate with respect to a feature of property 101 (e.g., number of bedrooms/baths) and thus consumer 102 may use system 100 to collect and submit verified inspection imagery refuting the inaccuracies. In another example, consumer 102 may believe that the tax appraisal mischaracterizes the condition of property 101 (e.g., the tax appraisal lists the property condition as excellent, but in fact the property is significantly aged or damaged) and thus consumer 102 may use system 100 to collect and submit verified inspection imagery refuting the condition mischaracterization. Still further, in another example, tax appraisal authorities may validate and use automated condition assessments and/or automated valuations provided by system 100 for improving the accuracy of its appraisals generally and driving efficiency in tax assessment efforts, amongst any number of additional benefits, thereby saving taxpayers considerable money and reducing frustrations with current approaches.

As another example, as previously noted, in various embodiments system 100 may be utilized by governmental entities for code and/or permit compliance purposes. More specifically, in an embodiment, system 100 may be adapted to provide verified inspection materials and/or any automated condition assessments to code compliance authorities, thereby obviating the need for code compliance inspectors to visit property 101 to conduct an inspection. Example code compliance situations in which this may be useful are home renovations (e.g., compliance with permits and code), utility work (e.g., compliance with water/gas/electric code), and condemnation/eviction situations (e.g., confirming that necessary repairs were made to prevent condemnation or eviction).

One of ordinary skill in the art may recognize additional applications for system 100 within the scope of the present disclosure.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. A system for consumer-facilitated inspection of a property, comprising:
a mobile application configured to run on a mobile device operated by a consumer and to associate, with inspection imagery captured by the consumer at a property using the mobile device, at least one of a location of the mobile device at the time the inspection imagery is captured and a time at which the inspection imagery is captured;
a database containing at least information concerning a location of the property; and
a server configured to:
receive, from the mobile application, the inspection imagery and associated location and/or time information,
receive, from the database, the information concerning the location of the property, and
compare at least one of (i) the location associated with the inspection imagery with the property location information received from the database to verify whether the inspection imagery was captured at the property, and (ii) the time associated with the inspection imagery with a current time to verify whether the inspection imagery reflects a recent condition of the property as defined by a predetermined threshold.

2. A system according to claim 1, wherein the server includes a memory and a processor, the memory containing computer-readable instructions that when executed by the processor cause the server to perform the claimed functions.

3. A system according to claim 1, wherein the server is further configured to evaluate at least one of the following to determine whether the property is eligible for consumer-facilitated inspection of the property: (i) a complexity of the property, (ii) whether the database contains sufficient information about the property to verify that the inspection imagery was captured at the property, and (iii) whether the consumer has verified, through the mobile application, that the information about the property contained in the database is correct.

4. A system according to claim 1, wherein the server is further configured to process the inspection imagery provided by the mobile application to identify one or more features of the property present in the inspection imagery from which a condition of the property can be assessed.

5. A system according to claim 1, wherein the server is further configured to perform at least one of the following functions: (i) provide the verified inspection imagery to a human for performing an appraisal or evaluation, (ii) automatically appraise the value of the property, based at least in part on the verified inspection imagery, using an automated valuation model (AVM), and (iii) use the human-performed appraisal or evaluation and the inspection materials to improve the accuracy of an AVM.

6. A system according to claim 5, wherein the appraisal or evaluation is a loan appraisal or evaluation, or a property tax appraisal or evaluation.

7. A system according to claim 1, wherein the server is further configured to provide the verified inspection imagery to a property taxing authority as part of a property tax appeals process.

8. A system according to claim 1, wherein the server is further configured to provide the verified inspection imagery to a code/permit compliance authority as part of a code/permit compliance process.

9. A system according to claim 1, wherein the server is further configured to use information about the property obtained from the database to generate and present to the consumer, via the mobile application, instructions and/or requests for collecting the inspection imagery and inspection information.

10. A computerized method for consumer-facilitated inspection of a property, comprising:
associating, with inspection imagery captured by a consumer at a property, at least one of a location and a time at which the inspection imagery is captured;
receiving information concerning the location of the property; and
comparing at least one of (i) the location associated with the inspection imagery with property location information to verify whether the inspection imagery was captured at the property, and (ii) the time associated with the inspection imagery with a current time to verify whether the inspection imagery reflects a recent condition of the property as defined by a predetermined threshold.

11. A method according to claim 10, wherein the computerized method is performed by a server including a memory and a processor, the memory containing computer-readable instructions that when executed by the processor cause the server to perform the claimed functions.

12. A method according to claim 10, further including evaluating at least one of the following to determine whether the property is eligible for consumer-facilitated inspection of the property: (i) a complexity of the property, (ii) whether sufficient information about the property is available to verify that the inspection imagery was captured at the property, and (iii) whether the consumer has verified that the available information about the property is correct.

13. A method according to claim 10, further including processing the inspection imagery to identify one or more features of the property present in the inspection imagery from which a condition of the property can be assessed.

14. A method according to claim 10, further including at least one of the following: (i) providing the verified inspection imagery to a human for performing an appraisal or evaluation, (ii) automatically appraising the value of the property, based at least in part on the verified inspection imagery, using an automated valuation model (AVM), and (iii) using the human-performed appraisal or evaluation and the inspection materials to improve the accuracy of an AVM.

15. A method according to claim 14, wherein the appraisal or evaluation is a loan appraisal or evaluation, or a property tax appraisal or evaluation.

16. A method according to claim 10, further including providing the verified inspection imagery to a property taxing authority as part of a property tax appeals process.

17. A method according to claim 10, further including providing the verified inspection imagery to a code/permit compliance authority as part of a code/permit compliance process.

18. A method according to claim 10, further including using the available information about the property to generate and present, to the consumer, instructions and/or requests for collecting the inspection imagery and inspection information.

19. A computerized method for generating an appraisal or evaluation of a property, comprising:
evaluating at least one of the following to determine whether a property is eligible for consumer-facilitated inspection of the property: (i) a complexity of the property, (ii) whether sufficient information about the property is available to verify that the inspection imagery was captured at the property; and (iii) whether the consumer has verified that the available information about the property is correct;
if the property is determined eligible, directing a consumer to capture inspection imagery of the property using a mobile device running a mobile application;
associating, with the inspection imagery captured by the consumer at the property, a location and a time at which the inspection imagery is captured;
verifying, based on the location and time information associated with the inspection imagery, whether the inspection imagery was captured at the property and whether the inspection imagery reflects a recent condition of the property as defined by a predetermined threshold; and
if the inspection imagery is verified, performing at least one of the following:
(i) providing the verified inspection imagery to a human for performing an appraisal of the property; and
(ii) processing the inspection imagery to identify one or more features of the property present in the inspection imagery from which a condition of the property can be assessed, and appraising the value of the property, based at least in part on information about the property condition assessment, using an automated valuation model.

20. A method according to claim 19, wherein the appraisal or evaluation is used in connection with originating a loan, servicing a loan, assessing property taxes, or evaluating code compliance.
